(19) United States
(12) Patent Application Publication
(10) Pub. No.: US 2015/0273397 A1
(43) Pub. Date: Oct. 1, 2015

(54) SYSTEM FOR RECOVERY OF ELECTRODEPOSITION PAINT

(71) Applicant: ASAHI KASEI CHEMICALS CORPORATION, Tokyo (JP)

(72) Inventors: Yoshiro ARIMORI, Tokyo (JP); Toshiaki KANEKO, Tokyo (JP); Sachio ASANAGI, Tokyo (JP)

(73) Assignee: ASAHI KASEI CHEMICALS CORPORATION, Tokyo (JP)

(21) Appl. No.: 14/738,365

(22) Filed: Jun. 12, 2015

Related U.S. Application Data
(62) Division of application No. 13/144,390, filed on Jul. 13, 2011.

(30) Foreign Application Priority Data
Jan. 29, 2009 (JP) 2009-018728

(51) Int. Cl. B01D 61/14

(52) U.S. Cl. CPC B01D 61/145; B01D 61/147

(57) ABSTRACT

An object of the present invention is to provide a system for recovery of electrodeposition paint wherein the loss of the electrodeposition paint is not increased, even if the number of stages of a multistage recovery and washing process with a membrane filtration filtrate is reduced in electrodeposition painting. The system for recovery of electrodeposition paint of the present invention, in which a membrane filtration filtrate of electrodeposition bath liquid is supplied to a final stage washing tank of the multistage recovery and washing process with a membrane filtration filtrate, is characterized in that a filtrate obtained by membrane filtration of the final stage washing tank liquid is supplied to the final stage washing tank and concentrated liquid is supplied to the electrodeposition bath and/or a washing tank at other than the final stage.

### CROSS-REFERENCE TO RELATED APPLICATIONS

The present application is a divisional application of application Ser. No. 13/144,390, which is a U.S. National Stage of International Application No. PCT/JP2010/051161 filed Jan. 28, 2010, which published as WO 2010087412A1 on Aug. 5, 2010, the disclosures of which are expressly incorporated by reference herein in their entireties. Further, this application claims priority under 35 U.S.C. §119 and §365 of Japanese Application No. 2009-018728 filed Jan. 29, 2009.

### TECHNICAL FIELD

The present invention relates to a system for recovery of electrodeposition paint which reduces the loss of the electrodeposition paint in electrodeposition painting, while maintaining good painting finish.

### BACKGROUND ART

Electrodeposition painting has been widely used in painting of automotive bodies, automotive parts, electric products and construction materials and the like. An electrodeposition painting system is composed of an electrodeposition step for forming a paint film electrochemically on an object to be painted, a cleaning step for washing off non-electrodeposited paint or the like and a drying-baking step for hardening of the paint film, and the cleaning step is generally comprised of two processes, i.e., a multistage recovery and washing process with a membrane filtration filtrate and a final washing process.

The multistage recovery and washing process with a membrane filtration filtrate is a process for cleaning the object to be painted after the electrodeposition step with a filtrate obtained by filtering an electrodeposition bath liquid with a membrane, and washing off the non-electrodeposited paint adhered physically to the object to be painted, as well as recovering it into the electrodeposition bath. In addition, the final washing process is a process for final cleaning using pure water or purified water (industrial water), and a trace amount of the paint or contaminated ions not washed off in the multistage recovery and washing process with the membrane filtration filtrate is washed off. In the final washing process, water after used for cleaning is discharged outside the process as waste water.

However, when there are many objects to be painted, a conventional recovery and washing method has the problem of increase in taken out amount of the paint outside electrodeposition painting facility, or the problem of increase in usage of purified water and pure water in the final washing process, and thus increase in waste water processing load, because of increase in concentration of non-electrodepositioned paint in each recovering washing tank. By increasing the number of stages of the multistage recovery and washing process with a membrane filtration filtrate, this problem can be solved. However, new problems of increase in installation cost and installation space are generated.

In order to solve the above problems, Patent document 1 describes filtering the recovered washing water of the first stage of the multistage recovery and washing process with a membrane filtration filtrate using an ultrafiltration membrane, and supplying the resultant filtrate to the final stage of the multistage recovery and washing process with a membrane filtration filtrate. However, this method has the problem in that amount of the filtrate obtained by ultrafiltration of the recovered washing water of the first stage is less and concentration of non-electrodepositioned paint in the final stage does not sufficiently decrease.

### PRIOR ART DOCUMENT

### Patent Document

### Patent Document 1: Japanese Unexamined Patent Publication No. 7-224397

### SUMMARY OF INVENTION

### Problem to be Solved by the Invention

In view of the above problems, it is an object of the present invention to provide a system for recovery of electrodeposition paint wherein the loss of the electrodeposition paint is not increased, even if the number of stages of the multistage recovery and washing process with a membrane filtration filtrate is reduced in electrodeposition painting. In addition, it is an object of the present invention to provide the system for recovery of electrodeposition paint wherein the loss of the paint can be reduced by efficiently increasing the washing liquid of the final stage in the multistage recovery and washing process with a membrane filtration filtrate.

### Means for Solving the Problem

The present invention provides the following aspects.

(1) A system for recovery of electrodeposition paint wherein a membrane filtration filtrate of electrodeposition bath liquid is supplied to a final stage washing tank of a multistage recovery and washing process with the membrane filtration filtrate, characterized by supplying a filtrate obtained by membrane filtration of the final stage washing tank liquid to the final stage washing tank, and supplying concentrated liquid to an electrodeposition bath and/or a washing tank at other than the final stage.

(2) The system for recovery of electrodeposition paint according to (1) above, wherein the membrane is a microfiltration membrane or an ultrafiltration membrane.

(3) The system for recovery of electrodeposition paint according to (2) above, wherein the membrane is the ultrafiltration membrane.

(4) The system for recovery of electrodeposition paint according to any one of (1) to (3) above, wherein washing tanks other than the final stage washing tank are arranged in plural and in parallel.

(5) The system for recovery of electrodeposition paint according to any one of (1) to (4) above, wherein amount of the filtrate obtained by membrane filtration of the final stage washing tank liquid of the multistage recovery and washing process with a membrane filtration filtrate is 2 to 10 times the amount of concentrated liquid supplied to the electrodeposition bath and/or the washing tank at other than the final stage.

(6) The system for recovery of electrodeposition paint according to any one of (1) to (5) above, wherein non-volatile matter content of paint of the concentrated liquid obtained by membrane filtration of the final stage washing tank liquid of the multistage recovery and washing process with a membrane filtration filtrate is 1.1 to 10 times the non-volatile matter content of paint of the final stage washing tank liquid.

(7) The system for recovery of electrodeposition paint according to any one of (1) to (6) above, wherein circulation by using a circulation pump is performed in membrane filtration of the final stage washing tank liquid.

(8) The system for recovery of electrodeposition paint according to (7) above, wherein the non-volatile matter content of paint of circulation liquid in membrane filtration of the final stage washing tank liquid is 0.5 to 5%.

(9) The system for recovery of electrodeposition paint according to any one of (1) to (8) above, wherein membrane filtration of the final stage washing tank liquid of the multistage recovery and washing process with a membrane filtration filtrate is performed under an average filtration pressure difference represented by the following formula, of 0.1 to 0.3 MPa.

Average Filtration Pressure Difference=(Inlet Pressure of Membrane Module+Outlet Pressure of Membrane Module)/2−Pressure at Filtration Side

(10) An apparatus for recovery of electrodeposition paint comprising an electrodeposition bath, a multistage recovery and washing process with a membrane filtration filtrate and a final washing process, wherein the apparatus comprises a first membrane filtration apparatus for filtrating electrodeposition bath liquid and a second membrane filtration apparatus for filtrating the final stage washing tank liquid of the multistage recovery and washing process with a membrane filtration filtrate.

(11) The apparatus for recovery of electrodeposition paint according to (10) above, wherein the second membrane filtration apparatus is provided with a circulation pump and a circulation line.

(12) The apparatus for recovery of electrodeposition paint according to (10) or (11) above, wherein washing tanks other than the final stage washing tank are arranged in plural and in parallel in the multistage recovery and washing process with a membrane filtration filtrate.

(13) The apparatus for recovery of electrodeposition paint according to any one of the above (10) to (12), wherein the multistage recovery and washing process with a membrane filtration filtrate is two stages.

### Effects of the Invention

According to the present invention, because the number of stages of the multistage recovery and washing process with a membrane filtration filtrate can be decreased without increasing the concentration of the non-electrodepositioned paint of the final stage washing tank of the multistage recovery and washing process with a membrane filtration filtrate, i.e., without increasing the loss of the electrodeposition paint, shortening of lead time in production and decrease in the installation space of the multistage recovery and washing process with a membrane filtration filtrate can be attained. In addition, in the case where the number of stages of the multistage recovery and washing process with a membrane filtration filtrate is the same number as in a conventional case, the loss of the electrodeposition paint can be reduced, because of decrease in concentration of non-electrodepositioned paint of the final stage washing tank.

### BRIEF DESCRIPTION OF THE DRAWINGS

FIG. 1 is a drawing showing one example of a conventional system for recovery of electrodeposition paint.

FIG. 2 is a drawing showing one example of a system for recovery of electrodeposition paint of the present invention.

FIG. 3 is a drawing showing one example of a membrane filtration apparatus to be used in a conventional system for recovery of electrodeposition paint.

FIG. 4 is a drawing showing one example of a membrane filtration apparatus to be used in a system for recovery of electrodeposition paint of the present invention.

Explanation will be given below in detail on the present invention with reference to drawings.

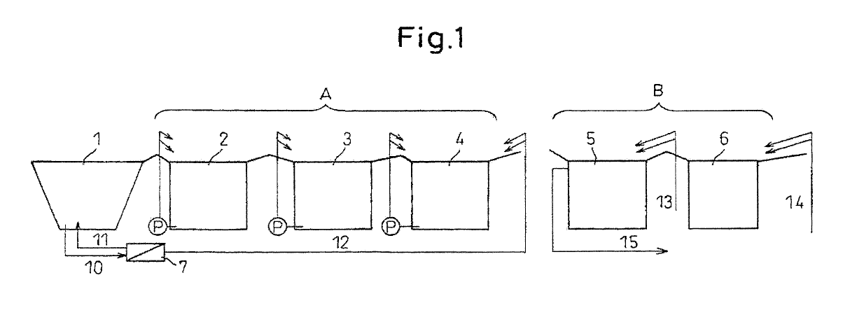

FIG. 1 is one example of a conventional system for recovery of electrodeposition paint, and in the drawing, 1 is an electrodeposition bath, A is a multistage recovery and a washing process for a membrane filtration filtrate and B is a final washing process. The multistage recovery and washing process with a membrane filtration filtrate (A) is composed of three stages of a first washing tank 2, a second washing tank 3 and a third washing tank 4; and the final washing process (B) is composed of two stages of a first washing tank 5 and a second washing tank 6. An object to be painted is mounted on a conveyer (not shown) and dipped in the electrodeposition bath, and after subjected to electrodeposition painting, transported to the first washing tank, the second washing tank and the third washing tank of the multistage recovery and washing process with a membrane filtration filtrate, and the first washing tank and the second washing tank of the final washing process sequentially for washing. 7 is a first membrane filtration apparatus. Electrodeposition bath liquid is sent from the electrodeposition bath to the first membrane filtration apparatus by a line 10, and subjected to membrane filtration. Concentrated liquid not to permeate the membrane is returned to the electrodeposition bath by a line 11. A filtrate is sent to a final stage of the multistage recovery and washing process with a membrane filtration filtrate, in this example, the third washing tank, by a line 12, and used as washing water of the multistage recovery and washing process with a membrane filtration filtrate. The washing water of the multistage recovery and washing process with a membrane filtration filtrate is overflowed sequentially from the third washing tank 4 to the second washing tank 3 and the first washing tank 2, and after used as washing water in each washing tank, further overflowed from the first washing tank 2 to the electrodeposition bath 1, and thus the non-electrodepositioned paint is recovered. To the first washing tank 5 of the final washing process, pure water or purified water (artificial water) is supplied as washing water from a line 13, and to the second washing tank 6, pure water or purified water (industrial water) is supplied from a line 14 for cleaning. Pure water supplied to the second washing tank 6 is overflowed to the first washing tank 5, and discharged from a line 15 together with purified water supplied to the first washing tank.

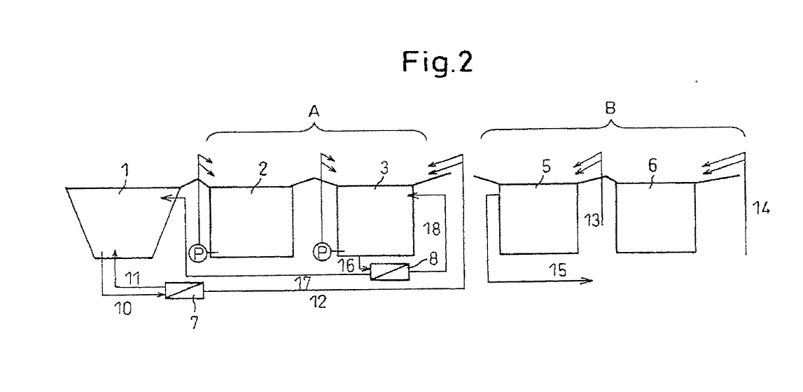

FIG. 2 is one example of a system for recovery of electrodeposition paint of the present invention. In FIG. 2, the same apparatus as in FIG. 1 has the same number. The present invention is characterized in that, compared with a conventional system, the third washing tank 4 is eliminated in the multistage recovery and washing process with a membrane filtration filtrate (A), and the multistage recovery and washing process with a membrane filtration filtrate has a two-stage configuration, and a second membrane filtration apparatus 8 is newly installed, and other than the above-described points are the same as in the conventional system. To the second membrane filtration apparatus 8, the final stage washing tank liquid of the multistage recovery and washing process with a membrane filtration filtrate, in this example, the second washing tank liquid, is supplied from a line 16, and concentrated liquid not to permeate the membrane is returned to an electrodeposition bath by a line 17. A filtrate is supplied to the second washing tank 3 (the final stage of the multistage recovery and washing process with a membrane filtration filtrate) by a line 18, and used as washing water along with the filtrate of the first membrane filtration apparatus 7 supplied by the line 12.

By decreasing the number of stages of the multistage recovery and washing process with a membrane filtration filtrate, installation space of the multistage recovery and washing process with a membrane filtration filtrate can be reduced, and by installing the second membrane filtration apparatus, increase in the non-electrodepositioned paint at the final stage, caused by decrease in the number of stages, can be prevented, and thus loss of the paint can be suppressed.

In the present invention, an apparatus which has been used in a conventional system can be used under operation condition used in the conventional system without any limitation, except the newly installed second membrane filtration apparatus. For example, although an example of two stages as the final washing process was shown, of course one stage may be adopted. In the final washing process, various designs have been proposed, and also in the present invention, the conventionally known final washing process can be used without any limitation.

In addition, an example of the two-stage configuration as the multistage recovery and washing process with a membrane filtration filtrate was shown, however a configuration of three stages or more may be employed. In the case where the number of stages is the same as in a conventional system, decrease in installation space is not attained, however, non-electrodepositioned paint of the final stage washing tank decreases and thus the loss of the electrodeposition paint can be decreased. In view of enabling shorter lead time and suppressed installation space, the two-stage configuration is most preferable.

Further, it is preferable that washing tanks other than the final stage washing tank in the multistage recovery and washing process are arranged in plural and in parallel so that a plurality of washing lines are installed, because a stable operation is possible by another line, even in the case of stopping either of the lines.

Also in the first membrane filtration apparatus 7, the membrane filtration apparatus of electrodeposition bath liquid, which has been used in a conventional system for recovery of electrodeposition paint, can be used under conventional operation condition without any limitation.

In order to decrease the number of stages of the multistage recovery and washing process with a membrane filtration filtrate or decrease the paint loss of the final washing tank, it is necessary to increase washing water, i.e., increase the amount of the filtrate in the first membrane filtration apparatus. However, the electrodeposition bath liquid contains a large amount of the paint, and a non-volatile matter content of paint (NV) is usually about 10 to 25%. Such high NV has limitation in increasing amount of the filtrate in the first membrane filtration apparatus. It should be noted that in the present description, the non-volatile matter content of paint (NV) is a value measured in accordance with JISK5601-1-2.

The present invention is characterized in that the second membrane filtration apparatus is installed at the final stage of the multistage recovery and washing process with a membrane filtration filtrate, in the above example, at the second washing tank 3, in addition to the first membrane filtration apparatus. The second washing tank water is supplied to the second membrane filtration apparatus by the line 16, and the filtrate is returned to the second washing tank by the line 18, as washing water. Concentrated liquid, which did not permeate the membrane, is sent to the electrodeposition bath and/or a washing tank at other stage than the final stage of the multistage recovery and washing process (in this example, the first washing tank 2), which have higher NV than NV of the concentrated liquid, by the line 17. In view of increasing recovery rate of the paint, it is preferable to be sent to the electrodeposition bath.

By installing such a second membrane filtration apparatus, non-electrodepositioned paint of the final stage washing tank can be recovered efficiently, and NV of the final stage washing tank can be decreased.

In the system for recovery of electrodeposition paint, the amount of the filtrate increases when NV of processing liquid in membrane filtration is low. NV of the electrodeposition bath and each washing tank is the highest in the electrodeposition bath, and decreases step-wise in the order of the first washing tank, the second washing tank and the third washing tank of the multistage recovery and washing process with a membrane filtration filtrate. Therefore, NV of the final stage washing tank of the multistage recovery and washing process with a membrane filtration filtrate is the lowest, and thus it is efficient to filtrate the final stage washing tank liquid. Because NV of the final stage washing tank liquid is 0.5 to 5.0%, by filtrating the final stage washing tank liquid, the filtrate can be obtained in an amount of 2 to 10 times, as compared with the first membrane filtration apparatus which filters the electrodeposition bath liquid.

Because the amount of washing water to be supplied to the second washing tank 3 (the final stage of the multistage recovery and washing process with a membrane filtration filtrate) is an amount of the filtrate of the first membrane filtration apparatus, an amount of concentrated liquid of the second membrane filtration apparatus sent from the second washing tank 3 to the electrodeposition bath 1 should be below the amount of the filtrate of the first membrane filtration apparatus. As described above, because the amount of the filtrate of the second membrane filtration apparatus, which filters the final stage washing tank liquid of the multistage recovery and washing process with a membrane filtration filtrate, is 2 to 10 times the amount of the filtrate of the first membrane filtration apparatus, in the second membrane filtration apparatus, the amount of the filtrate to be sent to the second washing tank 3 by the line 18 should be controlled so as to be at least 2 to 10 times the amount of concentrated liquid to be sent to the electrodeposition bath by the line 17.

In addition, when the amount of the filtrate to be sent to the second washing tank 3 by the line 18 is more than 10 times the amount of the concentrated liquid sent to the electrodeposition bath by the line 17, NV of the concentrated liquid increases and obtaining efficiency of the filtrate could decrease. On the contrary, when it is below 2 times, NV of circulation liquid decreases and stability of the amount of the filtrate could be deteriorated.

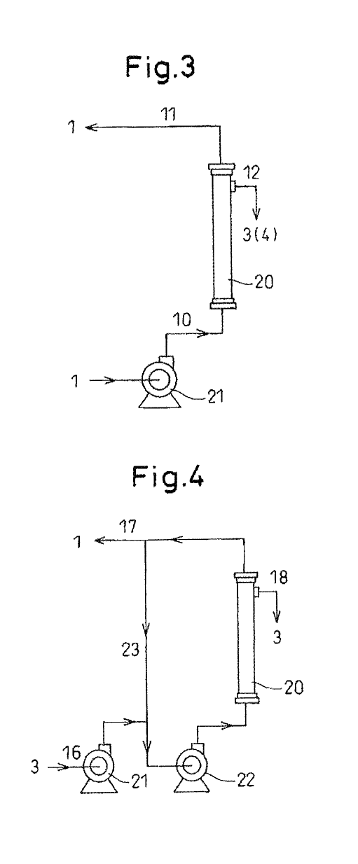

FIG. 3 is a drawing showing one example of a conventional membrane filtration apparatus used is a first membrane filtration apparatus. In FIG. 3, 20 in a membrane module and 21 is a supply pump. A filtrate to be sent to the second or the third washing tank is controlled so as to become 1 to 5 parts, relative to 100 parts of processing liquid to be supplied from the electrodeposition bath 1, and the residual 95 to 99 parts of the concentrated liquid, which did not permeate the membrane, has been returned to the electrodeposition bath 1. As the second membrane filtration apparatus, use of a conventional membrane filtration apparatus as shown in FIG. 3 makes difficult to be controlled as described above.

FIG. 4 is a drawing showing a preferable example of a membrane filtration apparatus to be used in a second membrane filtration apparatus. In FIG. 4, the same parts as in FIG. 3 have the same number. The second membrane filtration apparatus is characterized in that a circulation pump 22 and a circulation line 23 are installed, as compared with the first membrane filtration apparatus. 100 parts of processing liquid supplied from the second washing tank 3 is combined with liquid from the circulation line 23, increased to 1000 to 3000 parts, and supplied to the membrane module 20 with the circulation pump 22. It is controlled so that the amount of the filtrate to be returned to the second washing tank 3 becomes 70 to 90 parts, and the amount of the concentrated liquid to be sent to the electrodeposition bath 1 by the line 17 becomes 10 to 30 parts and is less than the amount of the filtrate of the first membrane filtration apparatus, and the residual concentrated liquid is circulated by the circulation line 23.

In addition, an NV of the concentrated liquid (circulated liquid) of the second membrane filtration apparatus is preferably 1.1 to 10 times, still more preferably 1.5 to 8 times, and particularly preferably 2 to 6 times NV of the second washing tank liquid. The NV of the concentrated liquid (circulated liquid) of the second membrane filtration apparatus over 10 times NV of the second washing tank liquid could increase NV of the concentrated liquid and could decrease the amount of the filtrate. On the contrary, the NV below 1.1 times could decrease NV of the circulated liquid and could deteriorate stability of the amount of the filtrate.

In order to operate the second membrane filtration apparatus shown in FIG. 4 under the above condition, the NV of processing liquid to be circulated to the membrane module 20 is preferably 0.5 to 5%, still more preferably 1 to 5%, and particularly preferably 2 to 5%. When the NV of the processing liquid to be circulated is within this range, paint components in the processing liquid can form a uniform cake layer at the inner plane of the membrane, and thus the amount of the filtrate can increase and also stability of operation for a long period of time can be satisfied.

In addition, in order to operate the second membrane filtration apparatus shown in FIG. 4 under the above condition, it is preferable to set average filtration pressure difference of the membrane module shown by the following formula at 0.05 to 0.40 MPa, and still more preferably 0.10 to 0.20 MPa.

Average Filtration Pressure Difference=(Inlet Pressure of Membrane Module+Outlet Pressure of Membrane Module)/2−Pressure at Filtration Side

A membrane to be used in the second membrane filtration apparatus is not especially limited, and for example, a reverse osmosis membrane (RO membrane), an ultrafiltration membrane (UF membrane) and a microfiltration membrane (MF membrane) and the like are included. Among these, use of the MF membrane and the UF membrane is preferable, and use of the UF membrane is particularly preferable.

The RO membrane has low processing capability per unit time and is not economically preferable. The MF membrane is superior in processing capability per unit time, however, some of paint components permeates the MF membrane.

On the contrary, the UF membrane has no problem in practical use as for both processing capability and removal capability of the paint components. As the UF membrane, the UF membrane having a fractionated molecular weight of about 3,000 to 1,000,000 is preferable, and also as for a material, any one of polyacrylonitrile, polysulfone, polyolefin, polyvinylidene fluoride (PVDF) and a chemically modified substance thereof or the like may be used.

As the membrane module, a membrane module, such as a hollow fiber-type, a spiral-type and a tubular-type, using the above UF membrane or the like, may also be used.

Electrodeposition paint to be used in the system for recovery of electrodeposition paint of the present invention is not limited, and it may be any electrodeposition paint such as cation electrodeposition paint and anion electrodeposition paint.

### EXAMPLES

Explanation will be given below in detail on the present invention with reference to the Example and Comparative examples, however, the present invention is not limited only to these Examples.

### Example

Using a system for recovery of electrodeposition paint shown in FIG. 2, electrodeposition painting was performed. As a first washing tank 2 of a multistage recovery and washing process with a membrane filtration filtrate (A) and a second washing tank 6 of a final washing process (B), a spray-type washing tank was used, and as a second washing tank 3 of the multistage recovery and washing process with a membrane filtration filtrate (A) and a first washing tank 5 of the final washing process (B), a dip-type washing tank was used. As a first membrane filtration apparatus 7, a membrane filtration apparatus shown in FIG. 3 was used, and as a membrane, an ultrafiltration membrane KCV-3010 manufactured by Asahi Kasei Chemicals Co., Ltd. was used. As a second membrane filtration apparatus 8, a membrane filtration apparatus shown in FIG. 4 was used, and as the membrane, the ultrafiltration membrane KCV-3010 manufactured by Asahi Kasei Chemicals Co., Ltd. was used.

As electrodeposition paint, cation electrodeposition paint was used to perform electrodeposition painting of an automobile.

An electrodeposition bath 1 is adjusted so that NV of the electrodeposition bath liquid becomes 20%. In the first membrane filtration apparatus 7, the amount of the electrodeposition bath liquid to be supplied from line 10 and the amount of a filtrate were set at 2700 L/min and 45 L/min, respectively. In the second membrane filtration apparatus 8, the amount of the second washing tank liquid to be supplied from line 16, the amount of the filtrate and the amount of the concentrated liquid (circulated liquid) to be sent to the electrodeposition bath 1 were set at 135 L/min, 100 L/min and 35 L/min, respectively. The amount of purified water to be supplied to the first washing tank of the final washing process, and the amount of pure water to be supplied to the second washing tank were both set at 50 L/min. Amount of liquid entrained from the second washing tank 3 of the multistage recovery and washing process with a membrane filtration filtrate to the first washing tank of the final washing process, being accompanied with an automobile of an object to be painted, is 12 L/min, and the equivalent liquid was carried out from the second washing tank of the final washing process. The amount of discharged liquid from the first washing tank of the final washing process was 100 L/min.

Paint recovery rate represented by the following formula and NV of each washing tank liquid, in operation under such condition, are shown in Table 1, along with the above setting condition.

Paint Recovery Rate=(1−NV of Final Washing Tank Liquid of Multistage Recovery and Washing Process with Membrane Filtration Filtrate/NV of Electrodeposition Bath Liquid)×100

In addition, NV of circulated liquid of the second membrane filtration apparatus, and average filtration pressure difference are also shown together in Table 1.

### Comparative Example 1

Electrodeposition painting was performed under similar setting conditions as in the Example, using the same system for recovery of electrodeposition paint as in Example, except that the second membrane filtration apparatus 8 was removed. Resultant paint recovery rate and NV of each washing tank and the like, are shown in Table 1, as well as setting condition.

### Comparative Example 2

In the system for recovery of electrodeposition paint used in Example, the second membrane filtration apparatus 8 was removed, and electrodeposition painting was performed under similar conditions as in the Example using the system for recovery of electrodeposition paint installed with the third washing tank 4 after the second washing tank 3, i.e., the system for recovery of electrodeposition paint shown in FIG. 1.

Resultant paint recovery rate and NV of each washing tank and the like, are shown in Table 1, as well as setting condition.

TABLE 1

| | | Example | Comparative | Comparative |
|---|---|---|---|---|
| | | 1 | Example 1 | Example 2 |
| Amount Entrained from Multistage Recovery and Washing | L/min | 12.0 | 12.0 | 12.0 |
| Process to Final Washing Process | | | | |
| NV of Electrodeposition Bath Liquid | % | 20.0 | 20.0 | 20.0 |
| Supply Amount to First Membrane Filtration Apparatus | L/min | 2700 | 2700 | 2700 |
| Filtrate Amount of First Membrane Filtration Apparatus | L/min | 45 | 45 | 45 |
| Supply Amount to Second Membrane Filtration Apparatus | L/min | 135 | Non | Non |
| Filtrate Amount of Second Membrane Filtration Apparatus | L/min | 100 | Non | Non |
| Draw out Amount of Concentrated Liquid of Second Film | L/min | 35 | Non | Non |
| Filtration Apparatus | | | | |
| Circulation Amount of Second Film Filtration Apparatus | L/min | 2100 | Non | Non |
| Supply Amount of Pure Water | L/min | 50 | 50 | 50 |
| Supply Amount of Purified Water | L/min | 50 | 50 | 50 |
| Amount of Discharge Water | L/min | 100 | 100 | 100 |
| NV of First Washing Tank Liquid of Multistage Recovery and | % | 3.73 | 5.31 | 5.56 |
| Washing Process | | | | |
| NV of Second Washing Tank Liquid of Multistage Recovery | % | 1.01 | 2.17 | 2.48 |
| and Washing Process | | | | |
| NV of Third Washing Tank Liquid of Multistage Recovery | % | Non | Non | 0.89 |
| and Washing Process | | | | |
| NV of First Washing Tank Liquid of Final Washing Process | % | 0.12 | 0.25 | 0.10 |
| NV of Second Washing Tank Liquid of Final Washing Process | % | 0.02 | 0.04 | 0.02 |
| NV of Filtrate of First Membrane Filtration Apparatus | % | 0.55 | 0.55 | 0.55 |
| NV of Filtrate of Second Membrane Filtration Apparatus | % | 0.50 | Non | Non |
| NV of Circulation Liquid of Second Membrane Filtration | % | 3.00 | Non | Non |
| Apparatus | | | | |
| Average Filtration Pressure Difference of Second Membrane | Mpa | 0.15 | Non | Non |
| Filtration Apparatus | | | | |
| Paint Recovery Rate | % | 95.0 | 89.2 | 95.5 |

As is clear from Table 1, the system for recovery of electrodeposition paint of the present invention provided with the second membrane filtration apparatus can provide paint recovery rate nearly equivalent to a conventional level, in spite of a small number of stages of the multistage recovery and washing process with a membrane filtration filtrate. Therefore, the system for recovery of electrodeposition paint of the present invention has shorter lead time and less installation space, compared with a conventional system for recovery of electrodeposition paint. In addition, in the case of using the same number of stages of the multistage recovery and washing process with a membrane filtration filtrate as in the conventional system for recovery of electrodeposition paint, paint recovery rate increases significantly, compared with a conventional system for recovery of electrodeposition paint.

### INDUSTRIAL APPLICABILITY

The system for recovery of electrodeposition paint of the present invention has shorter lead time and less installation space, or significantly increased paint recovery rate, as compared with a conventional system for recovery of electrodeposition paint. Therefore, industrial applicability of the present invention is significantly large.

### DESCRIPTION OF REFERENCE NUMERALS

1 Electrodeposition Bath
2 First Washing Tank of Multistage Recovery and Washing Process with Membrane Filtration Filtrate
3 Second Washing Tank of Multistage Recovery and Washing Process with Membrane Filtration Filtrate
4 Third Washing Tank of Multistage Recovery and Washing Process with Membrane Filtration Filtrate
5 First Washing Tank of Final Washing Process
6 Second Washing Tank of Final Washing Process
7 First Membrane Filtration Apparatus
8 Second Membrane Filtration Apparatus
20 Membrane Module
21 Supply Pump
22 Circulation Pump
23 Circulation Line
A Multistage Recovery and Washing Process for Membrane Filtration Filtrate
B Final Washing Process

1. A method for recovery of electrodeposition paint wherein a membrane filtration filtrate of electrodeposition bath liquid is supplied to a final stage washing tank of a multistage recovery and washing process with the membrane filtration filtrate, the method comprising:
supplying a filtrate obtained by membrane filtration of the final stage washing tank liquid to the final stage washing tank, and
supplying liquid not to permeate the membrane to an electrodeposition bath and/or a washing tank at other than the final stage.

2. The method for recovery of electrodeposition paint according to claim 1, wherein the membrane is a microfiltration membrane or an ultrafiltration membrane.

3. The method for recovery of electrodeposition paint according to claim 2, wherein the membrane is the ultrafiltration membrane.

4. The method for recovery of electrodeposition paint according to claim 1, wherein washing tanks other than the final stage washing tank are arranged in plural and in parallel.

5. The method for recovery of electrodeposition paint according to claim 1, wherein amount of the filtrate obtained by membrane filtration of the final stage washing tank liquid of the multistage recovery and washing process with a membrane filtration filtrate is 2 to 10 times amount of liquid not to permeate the membrane supplied to the electrodeposition bath and/or the washing tank at other than the final stage.

6. The method for recovery of electrodeposition paint according to claim 1, wherein non-volatile matter content of paint of the liquid not to permeate the membrane obtained by membrane filtration of the final stage washing tank liquid of the multistage recovery and washing process with a membrane filtration filtrate is 1.1 to 10 times the non-volatile matter content of paint of the final stage washing tank liquid.

7. The method for recovery of electrodeposition paint according to claim 1, wherein circulation by a circulation pump is performed in membrane filtration of the final stage washing tank liquid.

8. The method for recovery of electrodeposition paint according to claim 7, wherein the non-volatile matter content of paint of circulation liquid in membrane filtration of the final stage washing tank liquid is 0.5 to 5%.

9. The method for recovery of electrodeposition paint according to claim 1, wherein membrane filtration of the final stage washing tank liquid of the multistage recovery and washing process with a membrane filtration filtrate is performed under an average filtration pressure difference represented by the following formula, of 0.1 to 0.3 MPa:
Average Filtration Pressure Difference=(Inlet Pressure of Membrane Module+Outlet Pressure of Membrane Module)/2−Pressure at Filtration Side.
